(19) United States
(12) Patent Application Publication
(10) Pub. No.: US 2018/0013741 A1
(43) Pub. Date: Jan. 11, 2018

(54) MESSAGE PROCESSING DEVICE AND MESSAGE PROCESSING METHOD

(71) Applicant: FUJITSU LIMITED, Kawasaki-shi (JP)

(72) Inventors: Osamu Miyamoto, Ota (JP); Tomohiro Kawasaki, Yokohama (JP); Yuhei Shibukawa, Kawasaki (JP)

(73) Assignee: FUJITSU LIMITED, Kawasaki-shi (JP)

(21) Appl. No.: 15/603,775

(22) Filed: May 24, 2017

(30) Foreign Application Priority Data
Jul. 6, 2016 (JP) 2016-134562

(51) Int. Cl. H04L 29/06

(52) U.S. Cl. CPC H04L 63/08; H04L 63/04

(57) ABSTRACT

A message processing device includes a memory and a processor coupled to the memory. The processor is configured to receive a transmission instruction from a first information processing device. The transmission instruction includes a first message, first authentication information to be used for first authentication of authenticating a first user, and first identification information for identifying a first storage area. The processor is configured to identify the first storage area by using the first identification information. The processor is configured to store the first message in the identified first storage area. The processor is configured to perform the first authentication by using the first authentication information. The processor is configured to store, when the first authentication is successfully completed, information indicating authenticity in the first storage area in association with the first message.

### CROSS-REFERENCE TO RELATED APPLICATION

This application is based upon and claims the benefit of priority of the prior Japanese Patent Application No. 2016-134562, filed on Jul. 6, 2016, the entire contents of which are incorporated herein by reference.

### FIELD

The embodiments discussed herein are related to a message processing device and a message processing method.

### BACKGROUND

Recently, cloud services that provide virtual machines and middleware on the Internet are used and users are able to easily receive the services without preparing servers by themselves. Since data of multiple users who do not have relationships with each other is handled in the cloud, it is important to ensure the confidentiality of the data of the users. For example, the confidentiality is ensured by performing authentication in accordance with users' requests.

One of systems that operate in the cloud is a multi-tenant message queue system that provides a message queue, for example. A user is able to use the message queue system by executing an application programming interface (API) for operating a message queue in the cloud. The API for operating a queue may include generation of a queue, deletion of a queue, transmission of a message, and reception of a message.

Related techniques are disclosed in, for example, Japanese Laid-open Patent Publication No. 2011-170766.

For example, very high processing performance (for example, processing within several milliseconds to several tens of milliseconds) may be requested for the message queue system in a case where the message queue system is used for communication of information between different servers. In the message queue system, however, an authentication process may become a bottleneck and the processing performance may not be sufficiently improved, for example.

### SUMMARY

According to an aspect of the present invention, provided is a message processing device including a memory and a processor coupled to the memory. The processor is configured to receive a transmission instruction from a first information processing device. The transmission instruction includes a first message, first authentication information to be used for first authentication of authenticating a first user, and first identification information for identifying a first storage area. The processor is configured to identify the first storage area by using the first identification information. The processor is configured to store the first message in the identified first storage area. The processor is configured to perform the first authentication by using the first authentication information. The processor is configured to store, when the first authentication is successfully completed, information indicating authenticity in the first storage area in association with the first message.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a message queue system;

FIG. 2 is a diagram illustrating an example of timings of executing an authentication process and a queue operation process in message transmission;

FIG. 3 is a diagram illustrating a functional configuration of a message processing device according to a first embodiment;

FIG. 4 is a diagram illustrating a queue operation in message transmission according to the first embodiment;

FIG. 5 is a diagram illustrating an authentication process in a message transmission process according to the first embodiment;

FIG. 6 is a diagram illustrating an example of timings of executing an authentication process and a queue operation process in message reception;

FIG. 7 is a diagram illustrating a queue operation in message reception according to the first embodiment;

FIG. 8 is a diagram illustrating the queue operation in message reception;

FIG. 9 is a diagram illustrating an authentication process in a message reception process according to the first embodiment;

FIG. 10 is a diagram illustrating a process to be executed when authentication fails;

FIG. 11 is a diagram illustrating a message queue according to the first embodiment;

FIG. 12 is a diagram illustrating a cache according to the first embodiment;

FIG. 13 is a diagram illustrating an operational flow of a message transmission process according to the first embodiment;

FIG. 14 is a diagram illustrating a queue operation process in message transmission according to the first embodiment;

FIG. 15 is a diagram illustrating an operational flow of a message reception process according to the first embodiment;

FIG. 16 is a diagram illustrating a queue operation process in message reception according to the first embodiment;

FIG. 17 is a diagram illustrating a configuration of a message queue system according to a second embodiment;

FIG. 18 is a diagram illustrating a functional configuration of a message processing device according to the second embodiment;

FIG. 19 is a diagram illustrating an operational flow of a message transmission process according to the second embodiment;

FIG. 20 is a diagram illustrating a queue operation process in message transmission according to the second embodiment;

FIG. 21 is a diagram illustrating an operational flow of a message reception process according to the second embodiment;

FIG. 22 is a diagram illustrating a queue operation process in message reception in the second embodiment;

FIG. 23 is a diagram illustrating storage area information; and

FIG. 24 is a diagram illustrating a hardware configuration of a computer that achieves the message processing devices according to the embodiments.

### DESCRIPTION OF EMBODIMENTS

Hereinafter, embodiments are described in detail with reference to the accompanying drawings. Elements that are illustrated in multiple drawings and correspond to each other are indicated by the same reference numeral.

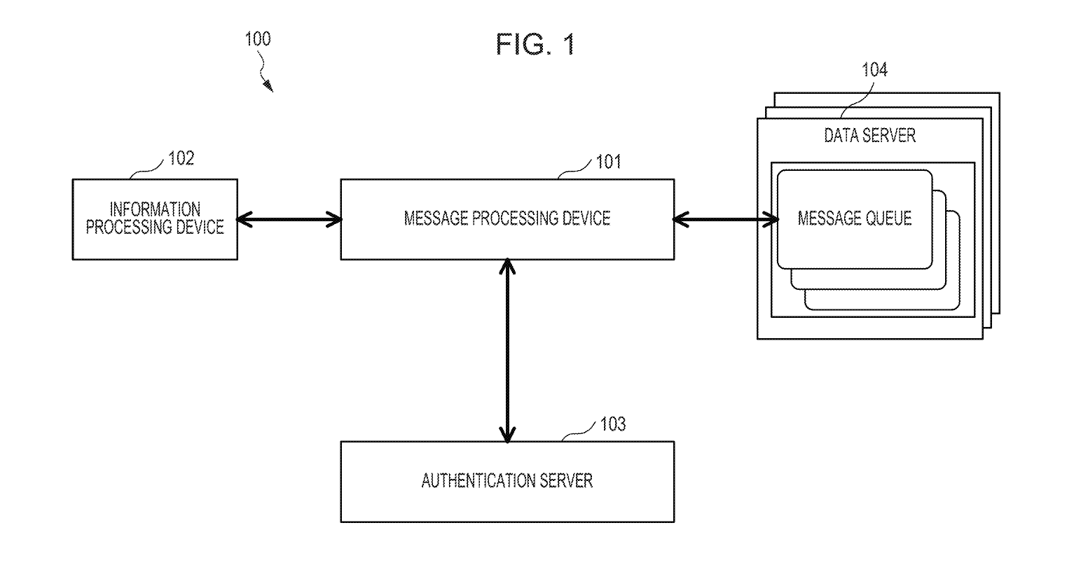

FIG. 1 is a diagram illustrating a configuration of a message queue system 100. The message queue system 100 includes a message processing device 101, an information processing device 102, an authentication server 103, and a data server 104, for example. The message queue system 100 may include a plurality of information processing devices 102. The message processing device 101 may be communicably coupled to the information processing device 102, the authentication server 103, and the data server 104. The message processing device 101 receives an operation instruction on a message queue from the coupled information processing device 102, for example. For example, the information processing device 102 outputs an operation instruction on a message queue to the message processing device 101 by calling, in the HyperText Transfer Protocol (HTTP) protocol, an API related to an operation on the message queue in the message processing device 101. The message queue is an example of a storage area for storing a message that is transmitted and received by a user. The message queue is hereinafter also merely referred to as a queue.

Upon receiving an operation instruction on a message queue, the message processing device 101 performs authentication of the user, who uses the information processing device 102 to input the operation instruction, by requesting the authentication server 103 to perform the authentication, for example. In addition, in accordance with the operation instruction on the message queue, the message processing device 101 operates, in the data server 104, a message queue of the user who inputs the operation instruction. The message queue system 100 may include a plurality of data servers 104. In this case, one of the data servers 104 may operate as a management server. The message processing device 101 may issue an inquiry about a data server in which the message queue is registered and may receive a response indicating the data server. The message processing device 101 may operate the message queue by requesting the target data server 104 to operate the message queue. Thus, in the message queue system 100, a plurality of information processing devices 102 may transmit and receive messages via the message processing device 101, for example.

When the message queue system 100 is used for communication of messages between different information processing devices 102 in the aforementioned manner, a very high processing speed (processing within several milliseconds to several tens of milliseconds) may be required for the message queue system 100 in some cases. However, since data of users who do not have relationships with each other is handled in the message queue system 100, it is important to ensure the confidentiality of data of the users. Thus, an authentication process may be executed in some cases. For example, in the message queue system 100, if a message queue is processed after the completion of the authentication process, the authentication process may become a bottleneck and the processing speed may not be sufficiently high.

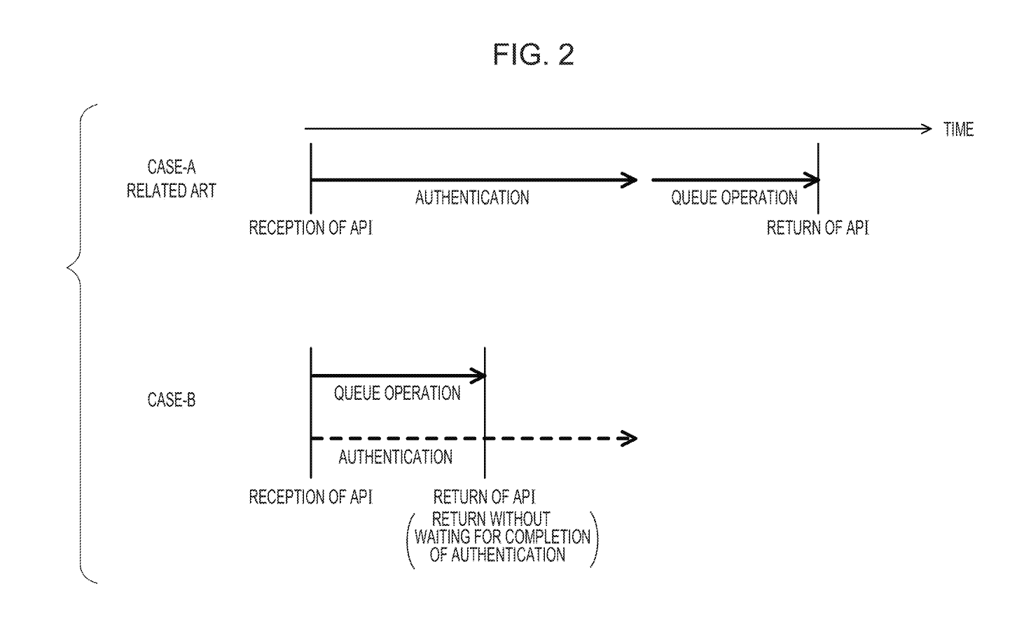

FIG. 2 is a diagram illustrating an example of timings of executing an authentication process and a queue operation process in message transmission. CASE-A in FIG. 2 indicates conventional timings of executing an authentication process and a queue operation process. In CASE-A, upon receiving a message transmission API, a conventional message processing device executes an authentication process. If authentication is successfully completed, the conventional message processing device performs a queue operation based on the message transmission API and returns the API. The conventional message processing device does not return the API until the completion of the authentication process and the completion of the queue operation process. Thus, it takes time. In the embodiments described below, the message processing device 101 starts a queue operation based on an API in parallel with an authentication process without waiting for the completion of authentication. For example, CASE-B in FIG. 2 indicates timings of executing the authentication process and the queue operation process in message transmission according to the embodiments. In CASE-B, the message processing device 101 starts the queue operation based on the API in parallel with the authentication process without waiting for the completion of authentication. In addition, the message processing device 101 returns the API without waiting for the completion of authentication. Therefore, a time elapsed for processing the API may be reduced and the processing performance of the message queue system may be improved. The embodiments are described below in detail.

### First Embodiment

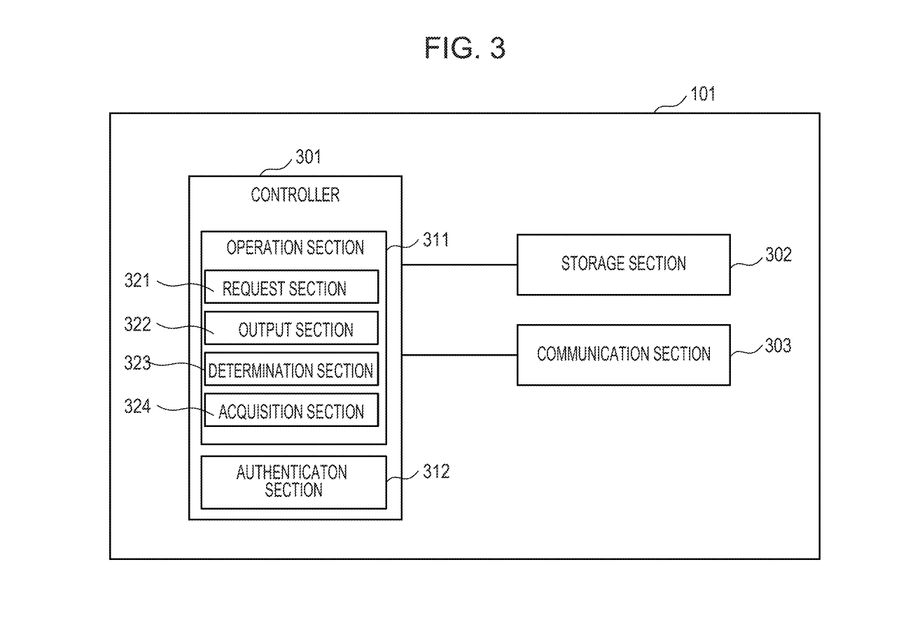

FIG. 3 is a diagram illustrating a functional configuration of the message processing device 101 according to the first embodiment. The message processing device 101 includes a controller 301, a storage section 302, and a communication section 303, for example. The controller 301 includes an operation section 311, an authentication section 312, and the like, for example. The operation section 311 includes a request section 321, an output section 322, a determination section 323, and an acquisition section 324, for example. The storage section 302 of the message processing device 101 stores information of a cache 1200 described later and the like, for example. The communication section 303 communicates with the information processing device 102, the authentication server 103, and the data server 104 in accordance with instructions from the controller 301, for example. The sections and the information stored in the storage section 302 are described later in detail.

A message transmission process and a message reception process that are executed by the message processing device 101 are described below. For example, the message transmission process is a process of storing a message received from the information processing device 102 in a message queue, and the message reception process is a process of providing a message retrieved from a message queue to the information processing device 102. First, the message transmission process is described.

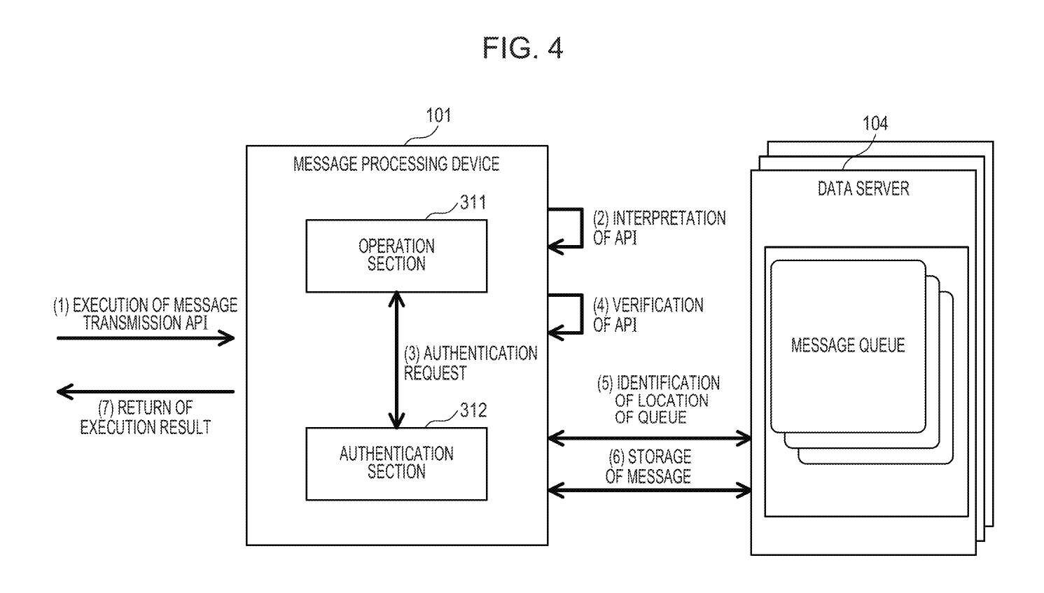

FIG. 4 is a diagram illustrating a queue operation in message transmission according to the first embodiment. For example, it is assumed that a user uses the information processing device 102 to call, in the HTTP protocol, a message transmission API that is an instruction to transmit a message to a message queue. The called API is received by the operation section 311 of the message processing device 101 ((1) in FIG. 4). The message transmission API may include a user-specific authentication token to be used for authentication of the user. The authentication token is an example of authentication information to be used for the authentication of the user, for example. The authentication token may be a key indicating the user subject to authentication, for example. The operation section 311 of the message processing device 101 interprets what kind of API the received API is and to which queue the received API is issued ((2) in FIG. 4). It is assumed that the operation section 311 determines that the received API is a message transmission API.

Then, the operation section 311 notifies the authentication section 312 of an authentication request for message transmission ((3) in FIG. 4). The authentication request for message transmission is a request for authentication of a user who uses the information processing device 102 that transmits the message. At this time, the operation section 311 gives, to the authentication section 312, an authentication token, a unique identifier (ID) that is specific information associated with the message, and identification information identifying a message queue in which the message is to be stored. In addition, the operation section 311 verifies the validity of the executed message transmission API without waiting for the result of the authentication ((4) in FIG. 4). For example, the operation section 311 verifies whether or not a parameter set in the message transmission API is valid and whether or not the format of the data transmitted by the message transmission API is valid.

Then, the operation section 311 identifies a location (a data server 104 and a specific region in the server) of the message queue to be operated in accordance with the message transmission API ((5) in FIG. 4). For example, the operation section 311 may issue, to the management server for managing the plurality of data servers 104, an inquiry about a data server 104 holding the message queue to be operated and about a specific region in the data server 104 in which the message queue is stored. Thus, the operation section 311 identifies the location of the message queue to be operated. Then, the operation section 311 instructs the data server 104 to store the message in the identified message queue ((6) in FIG. 4). The operation section 311 returns, to the information processing device 102 of the user, an execution result indicating that the execution of the message transmission API is completed ((7) in FIG. 4). As described above, since the operation section 311 causes the message to be stored in the message queue and returns the API execution result without waiting for the authentication result, processing time for the message transmission by the message queue system 100 may be reduced.

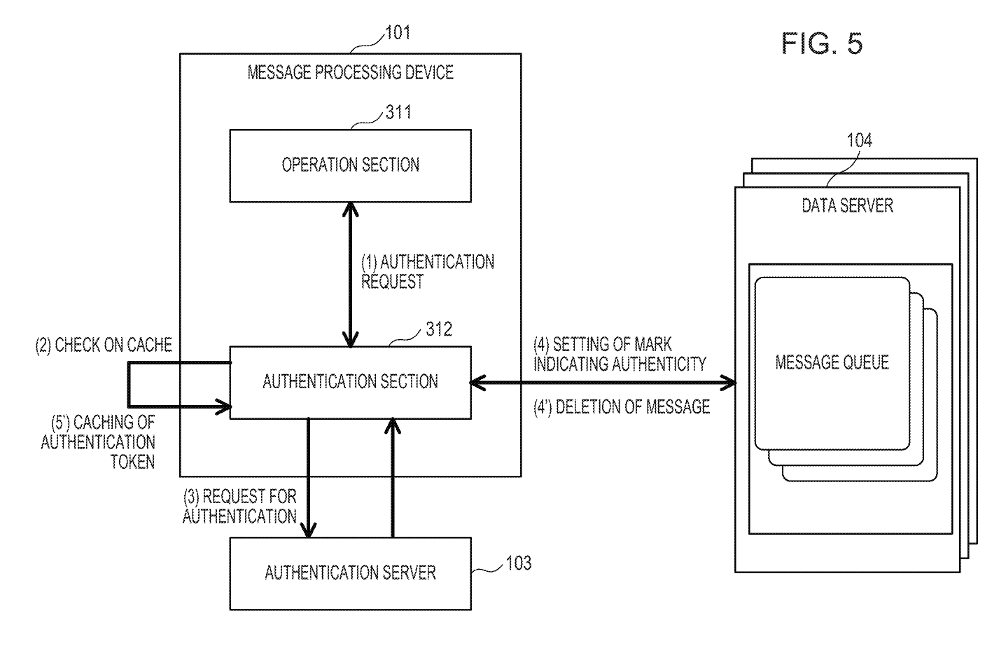

Next, the authentication process to be executed in the message transmission is described. FIG. 5 is a diagram illustrating the authentication process in the message transmission according to the first embodiment. The authentication process may be started when the authentication section 312 receives the authentication request for message transmission from the operation section 311 in (3) in FIG. 4, for example.

Upon receiving an authentication request for message transmission from the operation section 311 ((1) in FIG. 5), the authentication section 312 checks whether or not an authentication token identical to the authentication token received from the operation section 311 is already stored in the cache of the storage section 302 ((2) in FIG. 5). In the cache, an authentication token determined to be invalid in the past may be stored, as described later. For example, when an authentication token identical to the authentication token subject to authentication is already stored in the cache, the authentication section 312 immediately returns a response indicating rejection of the authentication to the operation section 311 and cancels the authentication request. On the other hand, when no authentication token identical to the authentication token subject to authentication is stored in the cache, the authentication section 312 requests the authentication server 103 to perform authentication and the authentication server 103 continues the authentication ((3) in FIG. 5).

When the authentication result from the authentication server 103 indicates that the authentication is successfully completed, the authentication section 312 instructs the data server 104 to associate a mark indicating authenticity with the message stored in the queue, which is subject to authentication ((4) in FIG. 5). When the authentication result indicates that the authentication is successfully completed, the authentication result may include information indicating the user corresponding to the authentication token. On the other hand, when the authentication result indicates that the authentication fails (or the authentication token is invalid), the authentication section 312 instructs the data server 104 to delete the message stored in the message queue, which is subject to authentication ((4′) in FIG. 5). Then, the authentication section 312 causes the authentication token for which the authentication fails to be stored as an invalid authentication token in the cache ((5′) in FIG. 5).

When the authentication is successfully completed, the mark indicating authenticity is associated with the message stored in the message queue. When the authentication fails, the message subject to authentication is deleted from the message queue. Thus, by checking the mark indicating authenticity before receiving the message, the destination of the message may suppress reception of an invalid message. According to the first embodiment, even if the operation section 311 causes a message to be stored in a message queue without waiting for an authentication result, the confidentiality of the message queue may be ensured.

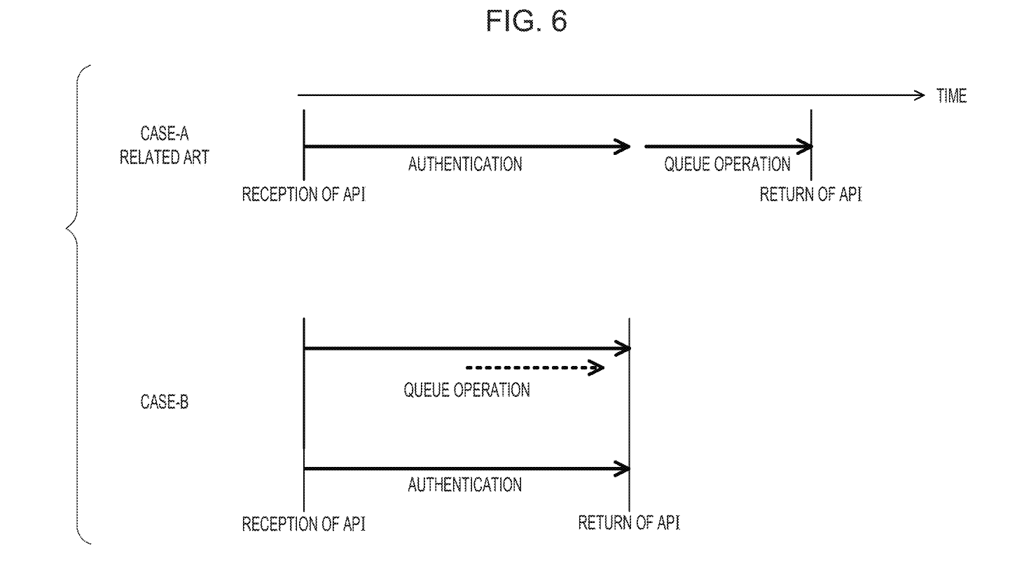

Next, the message reception process is described. FIG. 6 is a diagram illustrating an example of timings of executing an authentication process and a queue operation process in message reception. CASE-A in FIG. 6 indicates conventional timings of executing an authentication process and a queue operation process. In CASE-A in FIG. 6, upon receiving a message reception API, the conventional message processing device executes an authentication process. If the authentication is successfully completed, the conventional message processing device performs a queue operation based on the message reception API and returns the API. The conventional message processing device does not return the API until the completion of the authentication process and the completion of the execution of the queue operation process. Thus, it takes time. In the first embodiment, the message processing device 101 starts a queue operation based on the message reception API in parallel with an authentication process without waiting for the completion of authentication. CASE-B in FIG. 6 indicates timings of executing the authentication process and the queue operation process according to the first embodiment. As indicated by CASE-B in FIG. 6, the message processing device 101 according to the first embodiment starts the queue operation in parallel with the authentication process without waiting for the completion of authentication. Thus, in the message reception process, processing time may be reduced and the processing performance of the message queue system 100 may be improved. In the message reception, the API may be returned after the completion of the queue operation process and the completion of the authentication process. During the time when the operation section 311 waits for the completion of authentication, the mark indicating authenticity may be associated with the message registered in the message queue in response to a message transmission API and may be newly associated with the message. Thus, during the time when the operation section 311 waits for the completion of authentication, a process of checking the mark indicating authenticity, which is associated with the message registered in the message queue, may be executed (as indicated by a dotted line arrow in CASE-B in FIG. 6).

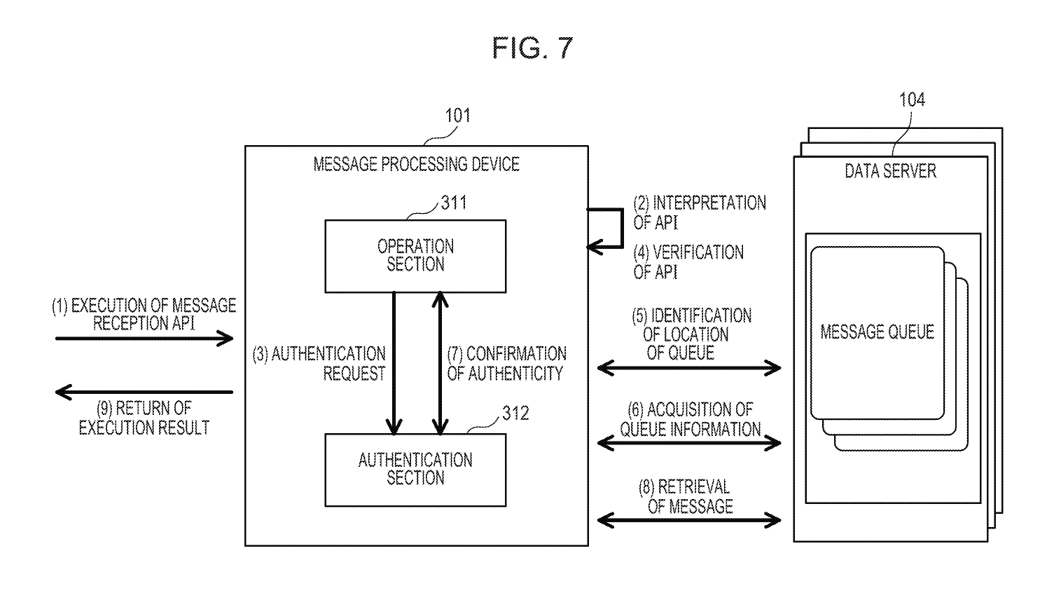

FIG. 7 is a diagram illustrating a queue operation in message reception according to the first embodiment. Processes (1) to (4) in FIG. 7 may be similar to the processes (1) to (4) in FIG. 4, for example. In the process (1) in FIG. 7, however, the operation section 311 receives a message reception API that is an instruction to receive a message from a message queue. The message reception API may include an authentication token indicating the information processing device 102 of the user who performs the queue operation. In the process (3) in FIG. 7, the operation section 311 notifies the authentication section 312 of an authentication request for message reception, which includes the authentication token. Then, the operation section 311 executes the process (4) in FIG. 7 without waiting for the result of the authentication and verifies the validity of the message reception API.

In (5) in FIG. 7, the operation section 311 identifies a location (a data server 104 and a specific region in the server) the message queue to be operated in accordance with the message reception API. For example, the operation section 311 may identify the location of the message queue by issuing an inquiry to the management server. In (6) in FIG. 7, the operation section 311 acquires information of the message queue and determines details of updating the message queue. For example, the operation section 311 may determine which message registered in the message queue is to be received and which message registered in the message queue is to be changed to which value. In addition, the operation section 311 sets already fixed information in a result (API execution result) of executing the API for preparing to return the API execution result. For example, the operation section 311 may set, in the base (frame) of the API execution result, a unique ID of the received message reception API and information such as the reception time.

In (7) in FIG. 7, the operation section 311 outputs a confirmation request for confirming authenticity to the authentication section 312, acquires the result of the authentication, and determines, based on the result of the authentication, whether or not the user has the right to operate the message queue to be operated in accordance with the message reception API. When the operation section 311 determines that the user has the right to operate the message queue to be operated in accordance with the message reception API, the operation section 311 acquires the message from the message queue to be operated and updates data of the message queue in (8) in FIG. 7. In the update of the data of the message queue, the operation section 311 deletes the message, for example. In (8) in FIG. 7, the operation section 311 acquires only the message with which the mark indicating authenticity is associated. In (9) in FIG. 7, the operation section 311 inserts the acquired message in the base of the API execution result and returns the API execution result to the user.

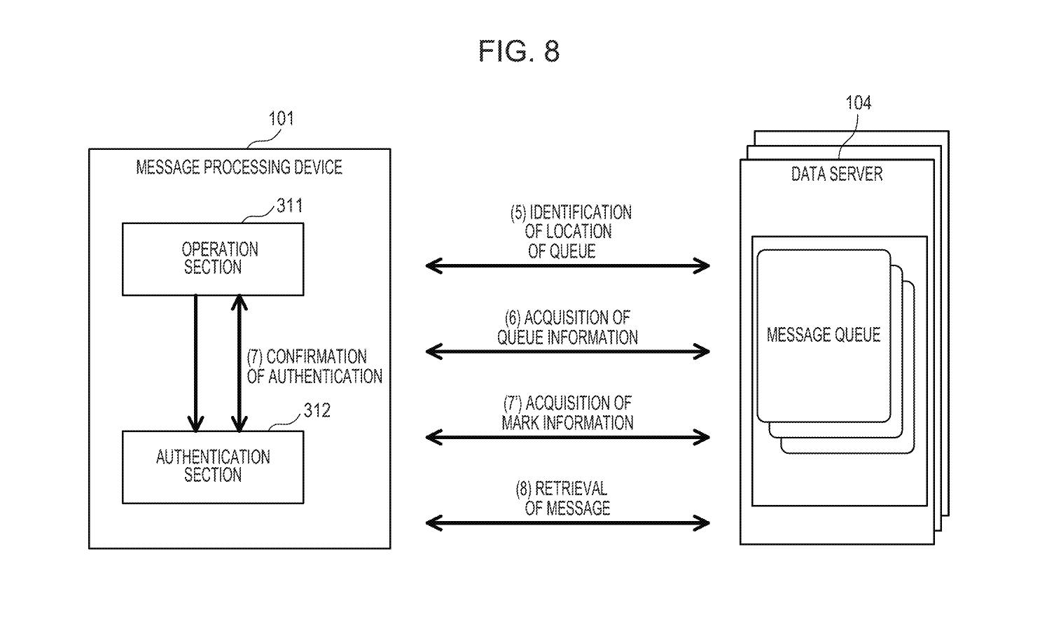

FIG. 8 is a diagram illustrating the processes (5) to (8) in FIG. 7. In (5) in FIG. 8, the operation section 311 identifies a location (a data server 104 and a specific region in the server) of the message queue to be operated in accordance with the message reception API. When the operation section 311 receives information of the message queue in (6) in FIG. 8, the operation section 311 outputs a confirmation request for confirming authenticity to the authentication section 312 in (7) in FIG. 8. The authentication section 312 confirms authenticity of the message by acquiring the mark indicating authenticity, which is associated with the message registered in the message queue, from the message queue in (7′) in FIG. 8. Then, the operation section 311 checks the result of the authentication on the basis of a response to the confirmation request and determines whether or not the user has the right to operate the message queue to be operated in accordance with the message reception API. When the user has the right to operate the message queue to be operated in accordance with the message reception API, the operation section 311 retrieves the message from the message queue ((8) in FIG. 8). If a time elapsed for executing the authentication process by the authentication section 312 is longer than a time elapsed for executing the queue operation process by the operation section 311, the operation section 311 may wait for the completion of authentication by the authentication section 312. In this case, during the time when the operation section 311 waits for the completion of authentication, the operation section 311 may execute a process of checking the mark indicating authenticity, which is associated with the message registered in the message queue to be operated in accordance with the message reception API, to recognize the latest authentication status of the message. Thus, in the message retrieval ((8) in FIG. 8), the operation section 311 may retrieve the message for which the authentication is successfully completed during the processes (5) to (7) in FIG. 8.

As described above, in the message reception process according to the first embodiment, since the authentication process and the queue operation process are executed in parallel, processing time may be reduced, and the processing performance of the message queue system 100 may be improved. Until the authentication is completed, the operation section 311 does not retrieve the message from the queue. Thus, the confidentiality of the message queue is ensured in the message reception. If the result of the authentication by the authentication section 312 indicates that the authentication fails in (7) in FIG. 8, the operation section 311 returns, to the information processing device 102, an API execution result indicating that the authentication fails. For example, if no message, with which the mark indicating authenticity is associated, exists in the message queue, the operation section 311 returns, to the information processing device 102, an API execution result indicating that no message exists.

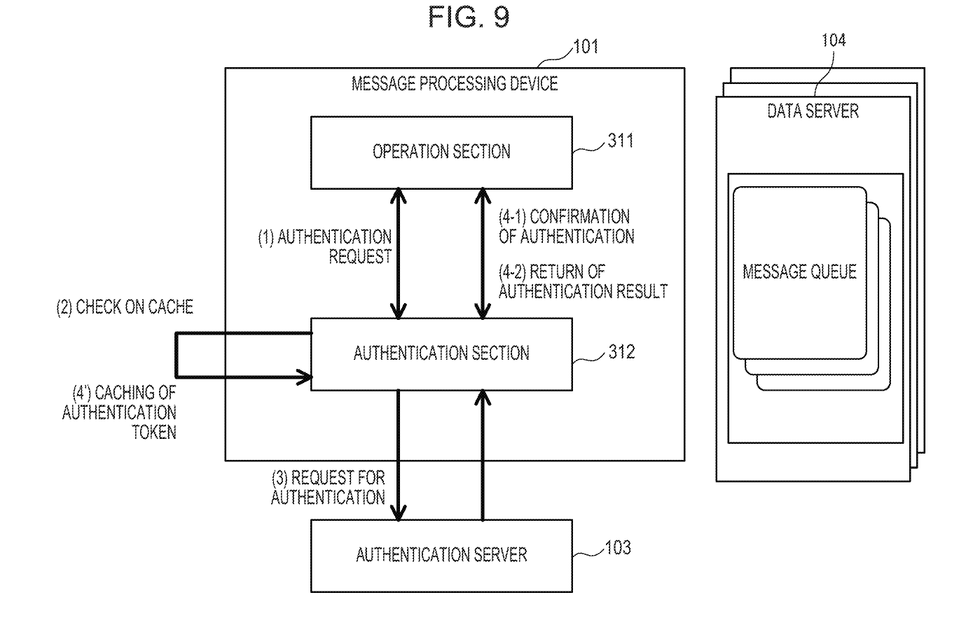

FIG. 9 is a diagram illustrating the authentication process in the message reception according to the first embodiment. The authentication process may be started when the authentication section 312 receives an authentication request for message reception from the operation section 311 in (3) in FIG. 7, for example.

Upon receiving an authentication request for message reception from the operation section 311 ((1) in FIG. 9), the authentication section 312 checks whether or not an authentication token identical to the authentication token received from the operation section 311 is already stored in the cache of the storage section 302 ((2) in FIG. 9). In the cache, an authentication token determined to be invalid in the past may be stored. When an authentication token identical to the authentication token subject to authentication is already stored in the cache, the operation section 311 immediately returns a response indicating rejection of the authentication to the operation section 311 and cancels the authentication request, for example. On the other hand, when no authentication token identical to the authentication token subject to authentication is stored in the cache, the authentication section 312 requests the authentication server 103 to perform authentication and the authentication server 103 continues the authentication ((3) in FIG. 9).

Upon receiving a confirmation request for confirming authenticity from the operation section 311 ((4-1) in FIG. 9), the authentication section 312 returns a result of the authentication to the operation section 311 ((4-2) in FIG. 9). If the authentication result from the authentication server 103 indicates that the authentication fails (or the authentication token is invalid), the authentication section 312 causes the authentication token for which the authentication fails to be stored in the cache ((4′) in FIG. 9).

As described above, since the message is returned to the user when the user authentication is successfully completed and the mark indicating authenticity is already associated with the message registered in the message queue, the confidentiality of the message queue may be ensured. In addition, since the message acquisition and the authentication are performed in parallel, a time elapsed for executing the message reception process may be reduced.

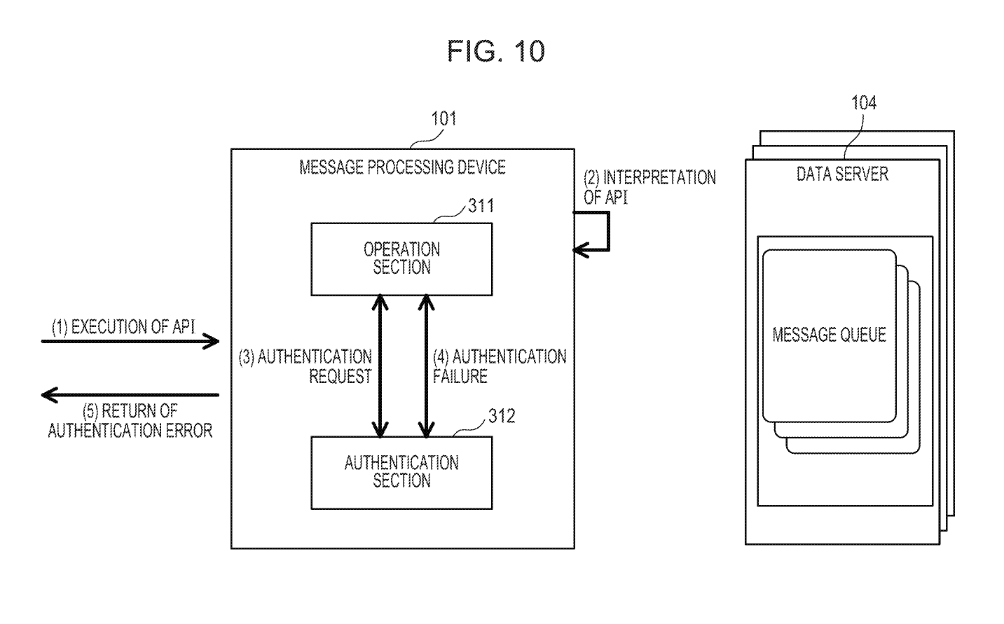

FIG. 10 is a diagram illustrating a process to be executed when authentication fails. The process illustrated in FIG. 10 may be applied to the message transmission and the message reception. For example, when the information processing device 102 of the user executes an API for operating a message queue of the user, the executed API is received by the operation section 311 of the message processing device 101 ((1) in FIG. 10). The operation section 311 of the message processing device 101 interprets what kind of API the received API is and to which queue the received API is issued ((2) in FIG. 10).

Then, the operation section 311 requests the authentication section 312 to perform authentication of the information processing device 102 that transmits the API ((3) in FIG. 10). It is assumed that the operation section 311 receives, form the authentication section 312, a notification indicating that the authentication fails ((4) in FIG. 10). In this case, the operation section 311 returns, to the user's information processing device 102 that requests the queue operation, an API execution result indicating that the authentication fails.

Next, operational flows of the aforementioned message transmission process and message reception process are described.

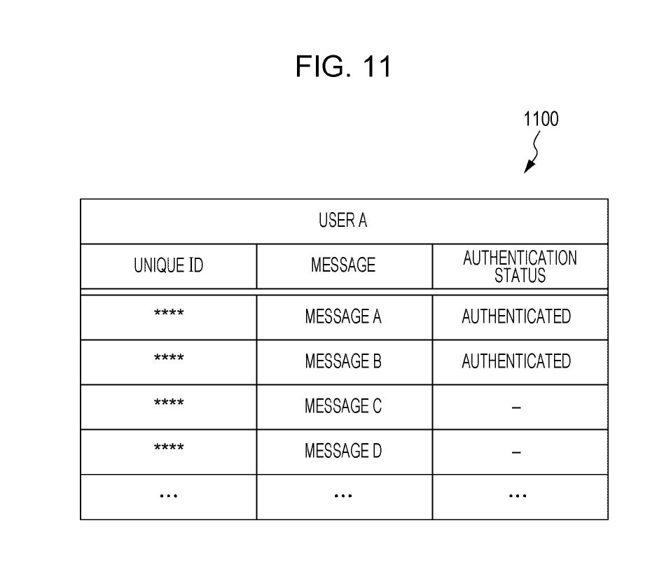

FIG. 11 is a diagram illustrating a message queue 1100 according to the first embodiment. The message queue 1100 may be stored in a storage device of the data server 104. In the message queue 1100, entries each including a unique ID, a message, and an authentication status of the message are registered, for example. The unique ID is a unique ID of the message transmission API used in the registration of the message of the entry in the message queue 1100, for example. The message is a message transmitted in accordance with the message transmission API, for example. The authentication status may be information indicating whether or not the message associated in the entry is already authenticated, for example. In the example illustrated in FIG. 11, when a message associated in an entry is already authenticated, “authenticated” is registered as the authentication status. When the message is not yet authenticated, “-”, which indicates that the message is not yet authenticated, is registered as the authentication status.

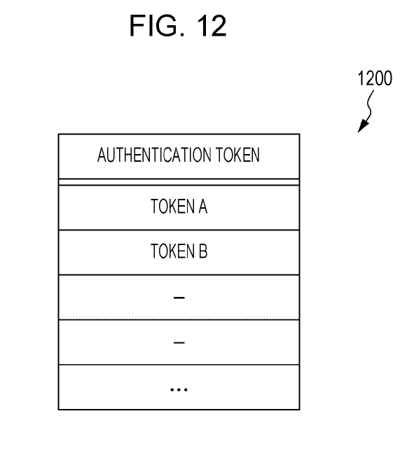

FIG. 12 is a diagram illustrating a cache 1200 for storing invalid authentication tokens. The cache 1200 may be stored in the storage section 302 of the message processing device 101, for example. As illustrated in FIG. 12, in the cache 1200, authentication tokens determined to be invalid are registered, for example.

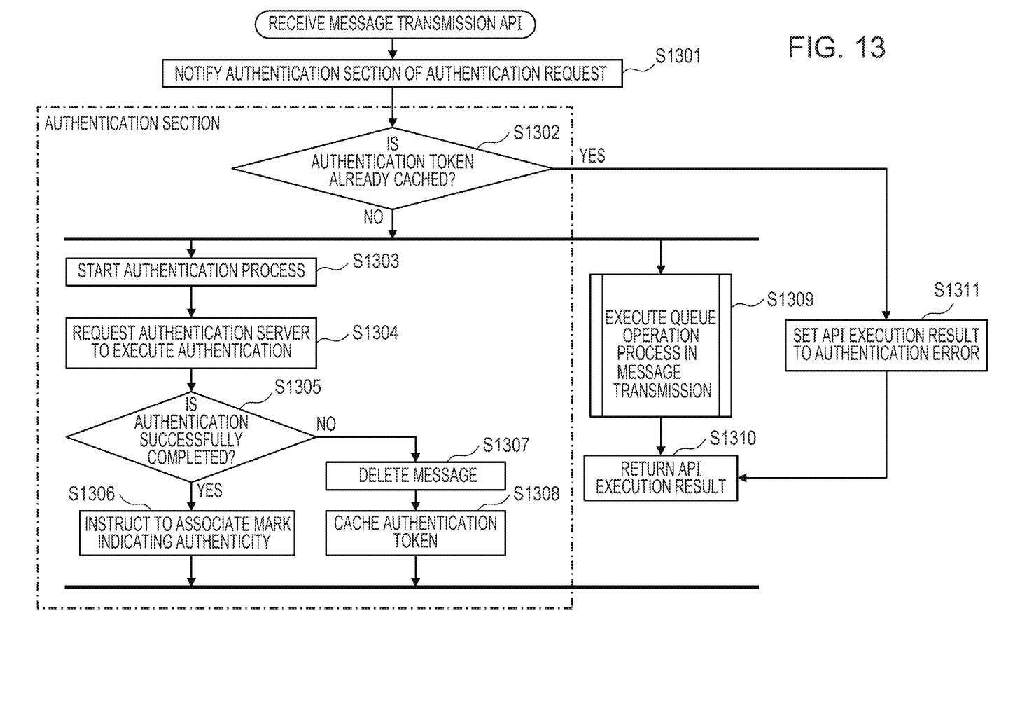

FIG. 13 is a diagram illustrating an operational flow of the message transmission process according to the first embodiment. The operational flow of the message transmission process illustrated in FIG. 13 may be started when the operation section 311 of the message processing device 101 receives a message transmission API.

In S1301, the operation section 311 acquires an authentication token included in the received message transmission API, a unique ID that is specific information associated with the message, and identification information identifying a queue in which the message is to be stored, and the operation section 311 notifies the authentication section 312 of an authentication request. In S1302, the authentication section 312 determines whether or not an authentication token identical to the authentication token included in the authentication request is already stored in the cache 1200.

When an authentication token identical to the authentication token is already stored in the cache 1200 (YES in S1302), the flow proceeds to S1311. In S1311, the operation section 311 sets information indicating an authentication error to an API execution result. Then, in S1310, the operation section 311 returns the API execution result, to which information indicating an authentication error is set, to the information processing device 102 that calls the message transmission API.

When no authentication token identical to the authentication token is stored in the cache 1200 (NO in S1302), the operation section 311 and the authentication section 312 start the processes in parallel. The authentication section 312 starts the authentication process in S1303 and transmits an authentication request to the authentication server 103 in S1304. In S1305, the authentication section 312 determines, based on an authentication result received as a response from the authentication server 103, whether or not the authentication is successfully completed. When the authentication is successfully completed (YES in S1305), the flow proceeds to S1306. In S1306, the authentication section 312 outputs, to the data server 104, an instruction to change, to “authenticated”, an authentication status of an entry of the message queue 1100, which includes the message subject to authentication, to cause the data server 104 to associate the mark indicating authenticity with the message. When S1306 is terminated, the authentication section 312 terminates the authentication process.

When the authentication fails (NO in S1305), the flow proceeds to S1307. In S1307, the authentication section 312 instructs the data server 104 to delete the entry including the message subject to authentication from the message queue 1100. In S1308, the authentication section 312 causes the authentication token used for the authentication to be stored as an invalid authentication token in the cache 1200 and terminates the authentication process.

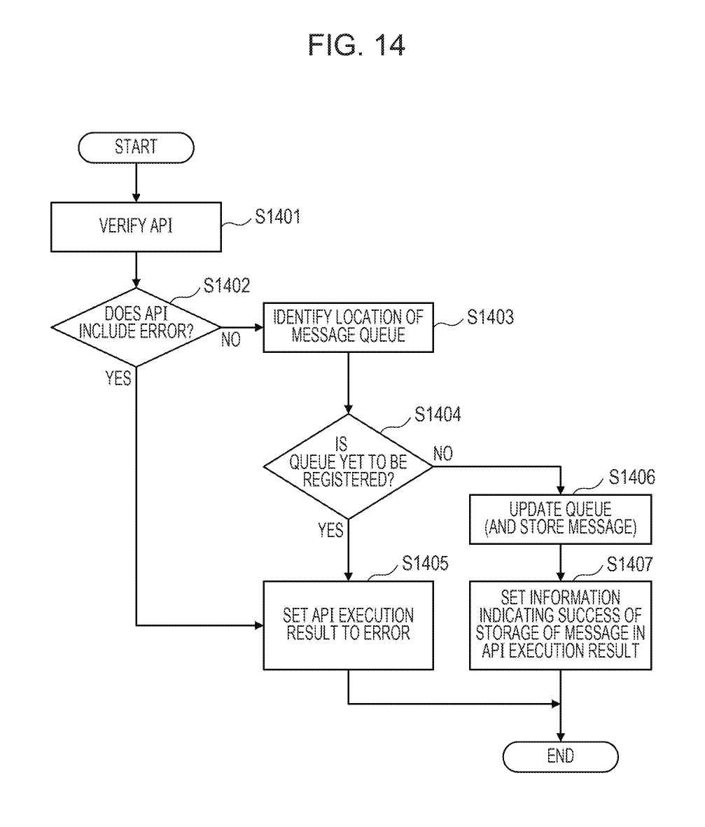

The operation section 311 executes a queue operation process in the message transmission in S1309 in parallel with the authentication process executed by the authentication section 312 in S1303. The queue operation process executed in the message transmission is described later in detail with reference to FIG. 14. When the queue operation process of S1309 is completed, in S1310, the operation section 311 returns an API execution result to the information processing device 102 that calls the message transmission API. In this case, the API execution result may include information indicating that the registration of the message in the message queue is completed, for example.

FIG. 14 is a diagram illustrating the queue operation process in the massage transmission according to the first embodiment. For example, when the flow proceeds to S1309 in FIG. 13, the operation section 311 may start executing the queue operation process illustrated in FIG. 14.

In S1401, the operation section 311 verifies the validity of the message transmission API. For example, the operation section 311 verifies whether or not a parameter set in the message transmission API is valid and whether or not the format of the data transmitted by the message transmission API is valid. Then, in S1402, the operation section 311 determines whether or not the message transmission API includes an error as a result of the API verification. When the message transmission API includes an error as a result of the API verification (YES in S1402), the flow proceeds to S1405. In S1405, the operation section 311 sets the API execution result to an error. Then, this operational flow is terminated and the flow of the message transmission process proceeds to S1310 in FIG. 13.

When the message transmission API includes no error as a result of the API verification (NO in S1402), the flow proceeds to S1403. In S1403, the operation section 311 identifies the location of the message queue specified as a queue to be operated in the message transmission API. For example, the operation section 311 may identify the location of the message queue by issuing an inquiry to the management server managing the data servers 104. In S1404, the operation section 311 determines, based on the result of the identification, whether or not the message queue specified as the queue to be operated in the message transmission API is yet to be registered. When the message queue specified as the queue to be operated in the message transmission API is yet to be registered and does not exist in any data server 104 (YES in S1404), the flow proceeds to S1405.

When the message queue specified as the queue to be operated in the message transmission API is already registered in the data server 104 (NO in S1404), the flow proceeds to S1406. In S1406, the operation section 311 outputs, to the data server 104, an instruction to store the message specified in the message transmission API in the message queue to be operated to update the message queue. In S1407, the operation section 311 sets, in the API execution result, information indicating that the storage of the message in the message queue is successfully completed. Then, this operational flow is terminated.

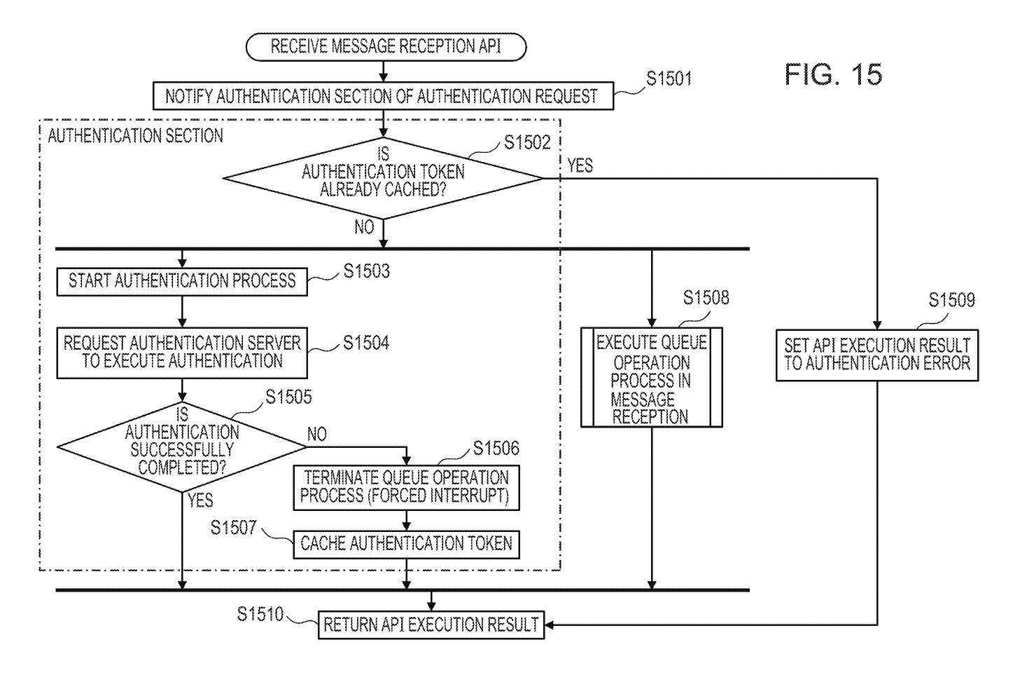

Next, an operational flow of the message reception is described. FIG. 15 is a diagram illustrating the operational flow of the message reception process according to the first embodiment. The operational flow of the message reception process illustrated in FIG. 15 may be started when the operation section 311 of the message processing device 101 receives a message reception API.

In S1501, the operation section 311 of the message processing device 101 acquires an authentication token included in the received message reception API and identification information identifying a queue in which a message is stored, and the operation section 311 notifies the authentication section 312 of an authentication request. In S1502, the authentication section 312 determines whether or not an authentication token identical to the authentication token included in the authentication request is already stored in the cache 1200.

When an authentication token identical to the authentication token is already stored in the cache 1200 (YES in S1502), the flow proceeds to S1509. In S1509, the operation section 311 sets information indicating an authentication error to an API execution result. Then, the flow proceeds to S1510. In S1510, the operation section 311 returns the API execution result, to which information indicating an authentication error is set, to the information processing device 102 that calls the message reception API.

When no authentication token identical to the authentication token is stored in the cache 1200 (NO in S1502), the operation section 311 and the authentication section 312 start the processes in parallel. The authentication section 312 starts an authentication process in S1503 and transmits an authentication request to the authentication server 103 in S1504. In S1505, the authentication section 312 determines, based on an authentication result received as a response from the authentication server 103, whether or not authentication is successfully completed. When the authentication is successfully completed (YES in S1505), the authentication section 312 terminates the authentication process and stands by until the completion of the process executed by the operation section 311.

When the authentication fails (NO in S1505), the flow proceeds to S1506. In S1506, the authentication section 312 outputs a notification indicating a forced interrupt to the operation section 311 and terminates the queue operation process. In S1507, the authentication section 312 causes the authentication token for which the authentication fails to be stored as an invalid authentication token in the cache 1200. Then, the authentication section 312 terminates the authentication process and stands by until the completion of the process executed by the operation section 311.

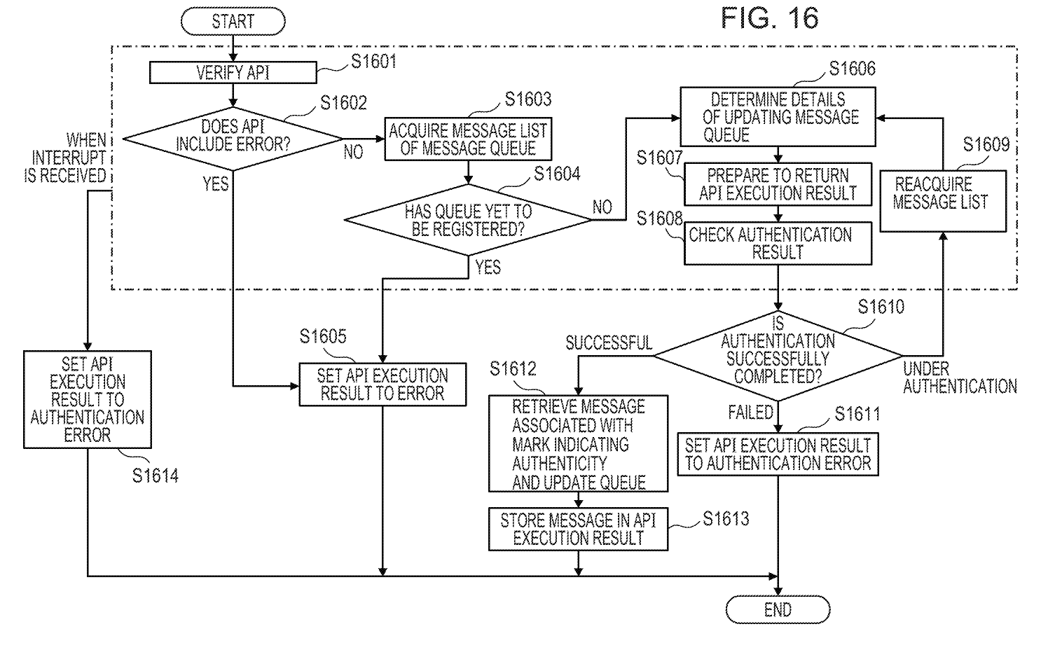

The operation section 311 executes a queue operation process in the message reception in S1508 in parallel with the authentication process executed by the authentication section 312. The queue operation process executed in the message reception is described later in detail with reference to FIG. 16. When the queue operation process of S1508 is completed, the operation section 311 stands by until the completion of the authentication process executed by the authentication section 312.

When the process executed by the operation section 311 and the authentication process executed by the authentication section 312 are completed, the operation section 311 returns the API execution result to the information processing device 102 that calls the message reception API. In this case, the API execution result may include the message retrieved from the message queue, for example.

FIG. 16 is a diagram illustrating a queue operation process in the message reception according to the first embodiment. For example, when the flow proceeds to S1508, the controller 301 may start executing the queue operation process illustrated in FIG. 16.

In S1601, the operation section 311 verifies the validity of the message reception API. For example, the operation section 311 verifies whether or not a parameter set in the message reception API is valid and whether or not the format of the data transmitted by the message reception API is valid. In S1602, the operation section 311 determines whether or not the message reception API includes an error. When the message reception API includes an error as a result of the API verification (YES in S1602), the flow proceeds to S1605. In S1605, the operation section 311 sets the API execution result to an error. Then, this operational flow is terminated and the flow of the message reception process proceeds to S1510 in FIG. 15.

When the message reception API includes no error as a result of the API verification (NO in S1602), the flow proceeds to S1603. In S1603, the operation section 311 tries to acquire a message list registered in the message queue specified as a queue to be operated in the message reception API. The message list may include a unique ID of the message and information of the mark indicating authenticity, which is associated with the message. In S1604, the operation section 311 determines whether or not the message queue 1100, which is specified in the message reception API as the queue to be operated, is yet to be registered. When the message queue 1100, which is specified in the message reception API as the queue to be operated, is yet to be registered and does not exist in any data server 104 (YES in S1604), the flow proceeds to S1605.

When the message queue 1100, which is specified in the message reception API as the queue to be operated, is already registered in a data server 104 (NO in S1604), the flow proceeds to S1606. In S1606, the operation section 311 determines details of updating the message queue 1100. In the determination of the details of updating, the operation section 311 may determine which message registered in the message queue 1100 is to be received from the data server 104 and which message registered in the message queue 1100 is to be changed to which value, based on the information of the mark indicating authenticity, which is associated with messages in the message list.

In S1607, the operation section 311 sets already fixed information in an API execution result to prepare to return the API execution result. For example, the operation section 311 may set, in the API execution result, a unique ID of the received message reception API and information such as the reception time of the received message reception API. In S1608, the operation section 311 notifies the authentication section 312 of a confirmation request for confirming authenticity to check the result of the authentication. In S1610, the operation section 311 determines whether or not the authentication is successfully completed.

When the authentication is being performed (“under authentication” in S1610), the operation section 311 reacquires the message list of the message queue 1100 to identify a message with which the mark indicating authenticity is associated in S1609. Then, the flow returns to S1606 and the operation section 311 re-determines details of updating the message queue.

When the authentication fails (“failed” in S1610), the flow proceeds to S1611, and the operation section 311 sets information indicating an authentication error to the API execution result in S1611. When the authentication is successfully completed (“successful” in S1610), the flow proceeds to S1612.

In S1612, the operation section 311 outputs, to the data server 104, a request instructing to transmit the message included in the message queue 1100, with which the mark indicating authenticity is associated, and to delete the entry including the transmitted message. Thus, the operation section 311 retrieves, from the data server 104, the message with which the mark indicating authenticity is associated, and the data server 104 updates the message queue 1100. In S1613, the operation section 311 causes the message retrieved from the message queue 1100 to be stored in the API execution result. Then, this operational flow is terminated.

For example, when the operation section 311 receives an interrupt from the authentication section 312 during the processes of S1601 to S1609, the flow proceeds to S1614. In S1614, the operation section 311 sets information indicating an authentication error to the API execution result, and this operational flow is terminated.

As described above, according to the first embodiment, since the controller 301 of the message processing device 101 performs authentication and a queue operation in accordance with an API in parallel, processing time may be reduced and the processing performance of the message queue system 100 may be improved.

For example, upon receiving a message transmission API from the information processing device 102, the controller 301 of the message processing device 101 outputs a request to register a message in the message queue 1100 without waiting for the completion of authentication and returns the API execution result. Since the controller 301 executes the process without waiting for the completion of authentication, and the processing time may be reduced.

When the authentication is successfully completed in the message transmission, the controller 301 of the message processing device 101 requests the data server 104 to associate the mark indicating authenticity with the message registered in the message queue 1100 in accordance with the message transmission API. Thus, in the message transmission, the confidentiality of the message queue 1100 may be ensured.

In addition, upon receiving a message reception API from the information processing device 102, the controller 301 of the message processing device 101 performs authentication and a queue operation in accordance with the message reception API in parallel, thus the processing time may be reduced. Then, the controller 301 returns an API execution result to the information processing device 102 based on the result of the authentication after completing the authentication. Then, in the message reception, the controller 301 acquires a message with which the mark indicating authenticity is associated. Thus, also in the message reception, the confidentiality of the message queue 1100 may be ensured.

When the authentication fails, the controller 301 causes an authentication token used for the authentication to be stored in the cache 1200, and thereafter, the controller 301 may quickly determine an authentication error in the message transmission and the message reception. When an authentication error is detected using the cache 1200, the controller 301 may omit at least a part of the processes of S1303 in FIG. 13 and later and the processes of S1503 in FIG. 15 and later. Thus, according to the first embodiment, the processing performance of the message queue system 100 may be improved.

In the aforementioned operational flow of the message transmission, the controller 301 operates as the request section 321 in S1304 in FIG. 13, for example. In addition, the controller 301 operates as the output section 322 in S1306 in FIG. 13, for example.

In the aforementioned operational flow of the message reception, the controller 301 operates as the determination section 323 in S1505 in FIG. 15, for example. In addition, the controller 301 operates as the acquisition section 324 in S1612 in FIG. 16, for example.

The first embodiment exemplifies the case where the authentication server 103 performs the authentication and the message queue 1100 is stored in the data server 104, as described with reference to FIG. 2. The embodiments, however, are not limited to this. For example, the message processing device 101, the authentication server 103, and the data server 104 may be implemented as a unified device including the message processing device 101, the authentication server 103, and the data server 104. Hereinafter, a second embodiment including the unified device is described.

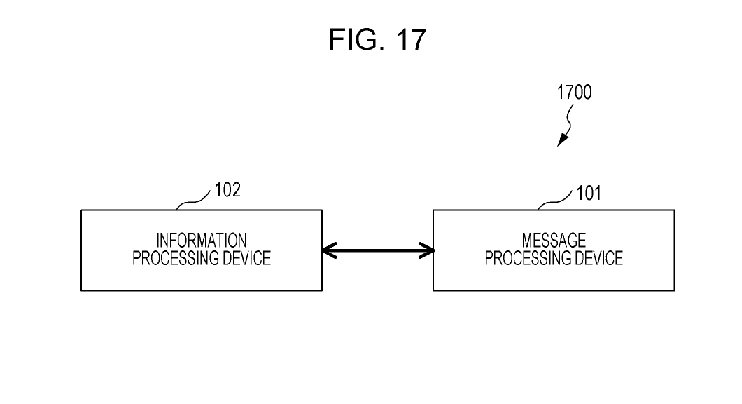

FIG. 17 is a diagram illustrating a message queue system 1700 according to the second embodiment. The message queue system 1700 includes a message processing device 101 and an information processing device 102. The message queue system 1700 may include a plurality of information processing devices 102. The message processing device 101 may be communicably coupled to the information processing device 102. The message processing device 101 receives an operation instruction on a message queue from the coupled information processing device 102. For example, the information processing device 102 outputs an operation instruction on a message queue to the message processing device 101 by calling, in the HTTP protocol, an API related to an operation on the message queue in the message processing device 101.

Upon receiving an operation instruction on a message queue, the message processing device 101 performs authentication of a user, who inputs the operation instruction, and operates a message queue of the user in accordance with the operation instruction on the message queue.

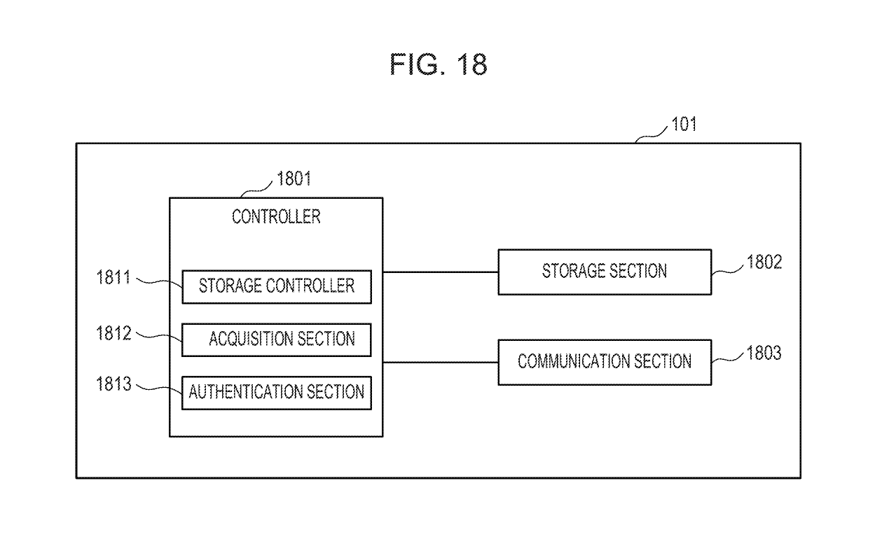

FIG. 18 is a diagram illustrating a functional configuration of the message processing device 101 according to the second embodiment. For example, the message processing device 101 includes a controller 1801, a storage section 1802, and a communication section 1803. The controller 1801 includes a storage controller 1811, an acquisition section 1812, an authentication section 1813, and the like, for example. The storage section 1802 of the message processing device 101 stores therein information such as information of the message queue 1100, the cache 1200, and storage area information 2300 described later. The communication section 1803 communicates with the information processing device 102 in accordance with an instruction from the controller 1801, for example. The sections and the information stored in the storage section 1802 are described later in detail. Operational flows of processes according to the second embodiment are exemplified below.

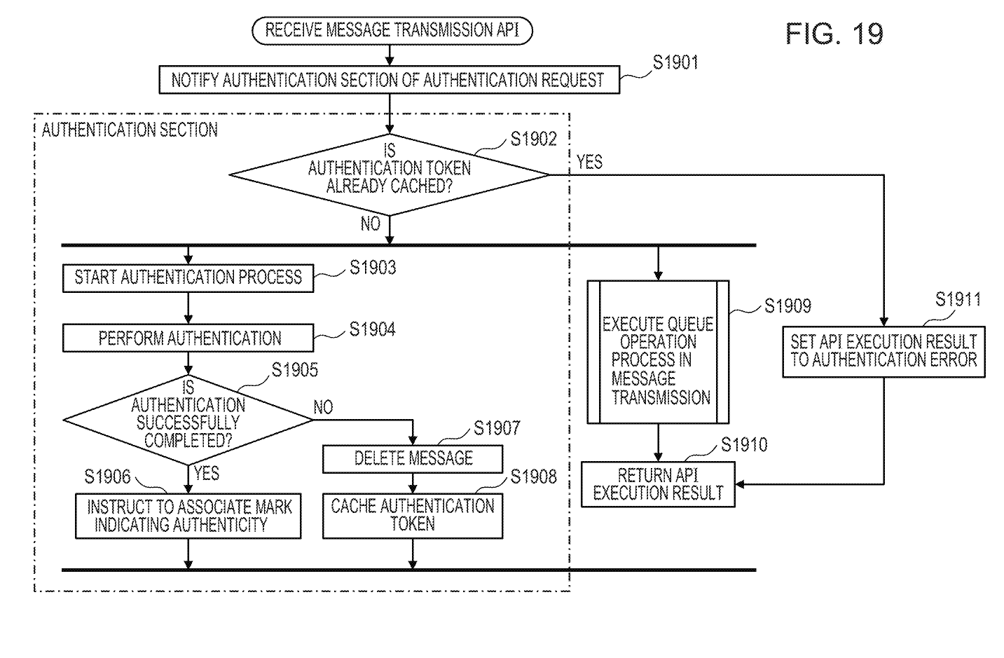

FIG. 19 is a diagram illustrating an operational flow of a message transmission process according to the second embodiment. The operational flow of the message transmission process illustrated in FIG. 19 may be started when the controller 1801 of the message processing device 101 receives a message transmission API.

In S1901, the controller 1801 acquires an authentication token included in the received message transmission API, a unique ID that is specific information associated with the message, and identification information identifying a queue in which the message is to be stored, and the controller 1801 notifies the authentication section 1813 of an authentication request. In S1902, the authentication section 1813 determines whether or not an authentication token identical to the authentication token included in the authentication request is already stored in the cache 1200.

When an authentication token identical to the authentication token is already stored in the cache 1200 (YES in S1902), the flow proceeds to S1911. In S1911, the controller 1801 sets information indicating an authentication error to an API execution result. Then, in S1910, the controller 1801 returns the API execution result, to which information indicating an authentication error is set, to the information processing device 102 that calls the message transmission API.

When no authentication token identical to the authentication token is stored in the cache 1200 (NO in S1902), the controller 1801 and the authentication section 1813 start processes in parallel. The authentication section 1813 starts the authentication process in S1903 and performs authentication in S1904. In S1905, the authentication section 1813 determines, based on the result of the authentication, whether or not the authentication is successfully completed. When the authentication is successfully completed (YES in S1905), the flow proceeds to S1906. In S1906, the authentication section 1813 changes, to “authenticated”, an authentication status of an entry of the message queue 1100, which includes the message subject to authentication, and associates the mark indicating authenticity with the message. When S1906 is terminated, the authentication section 1813 terminates the authentication process.

When the authentication fails (NO in S1905), the flow proceeds to S1907. In S1907, the authentication section 1813 deletes the entry including the message subject to authentication from the message queue 1100. In S1908, the authentication section 1813 causes the authentication token used for the authentication to be stored as an invalid authentication token in the cache 1200. Then, the authentication section 1813 terminates the authentication process.

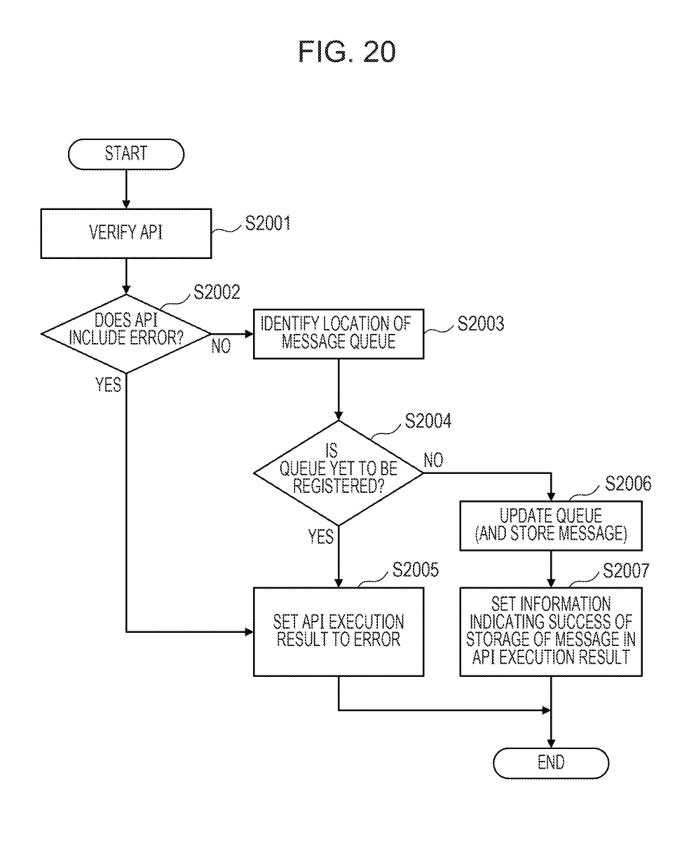

In S1909, the controller 1801 executes a queue operation process in the message transmission in parallel with the authentication process executed by the authentication section 1813 in S1903. The queue operation process executed in the message transmission is described later in detail with reference to FIG. 20. When the queue operation process of S1909 is completed, in S1910, the controller 1801 returns an API execution result to the information processing device 102 that calls the message transmission API. In this case, the API execution result may include information indicating that the registration of the message in the message queue is completed.

FIG. 20 is a diagram illustrating the queue operation process in the message transmission according to the second embodiment. For example, when the flow proceeds to S1909 in FIG. 19, the controller 1801 may start executing the queue operation process illustrated in FIG. 20.

In S2001, the controller 1801 verifies the validity of the message transmission API. For example, the controller 1801 verifies whether or not a parameter set in the message transmission API is valid and whether or not the format of the data transmitted by the message transmission API is valid. Then, in S2002, the controller 1801 determines whether or not the message transmission API includes an error as a result of the API verification. When the message transmission API includes an error as a result of the API verification (YES in S2002), the flow proceeds to S2005. In S2005, the controller 1801 sets the API execution result to an error. Then, this operational flow is terminated and the flow of the message transmission process proceeds to S1910 in FIG. 19.

When the message transmission API includes no error as a result of the API verification (NO in S2002), the flow proceeds to S2003. In S2003, the controller 1801 identifies, in the storage section 1802, the location of the message queue specified as a queue to be operated in the message transmission API. For example, the controller 1801 references the storage area information 2300 to identify a storage area corresponding to identification information identifying the message queue in which the message is to be stored. The storage area is information indicating the location of the message queue identified by the identification information in the storage section 1802.

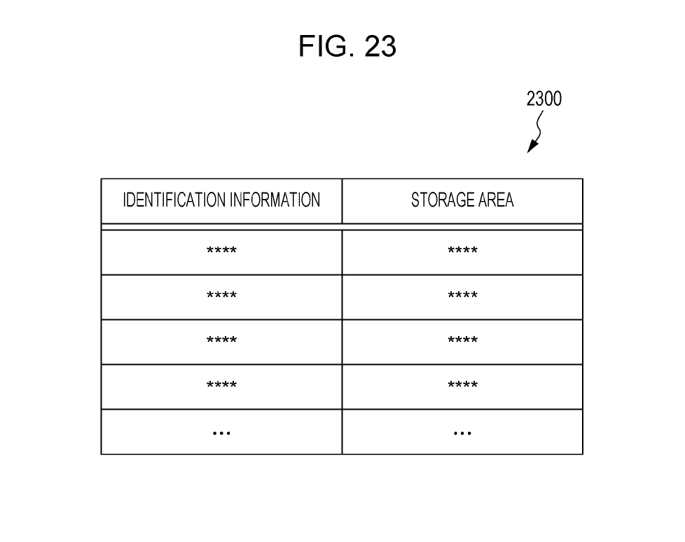

FIG. 23 is a diagram illustrating the storage area information 2300. In the storage area information 2300, identification information and information indicating a storage area are stored in association with each other. For example, the controller 1801 may reference the storage area information 2300 to identify the storage area corresponding to the identification information identifying the message queue in which the message is to be stored, and identify the message queue to be operated.

In S2004, the controller 1801 determines, based on the result of the identification, whether or not the message queue specified as the queue to be operated in the message transmission API is yet to be registered. When the message queue specified as the queue to be operated in the message transmission API is yet to be registered and does not exist in the storage section 1802 (YES in S2004), the flow proceeds to S2005.

When the message queue specified as the queue to be operated in the message transmission API is already registered in the storage section 1802 (NO in S2004), the flow proceeds to S2006. In S2006, the controller 1801 causes the message specified in the message transmission API to be stored in the message queue to be operated, which is included in the specified storage area of the storage section 1802, and updates the message queue. In S2007, the controller 1801 sets, in the API execution result, information indicating that the storage of the message in the message queue is successfully completed. Then, this operational flow is terminated.

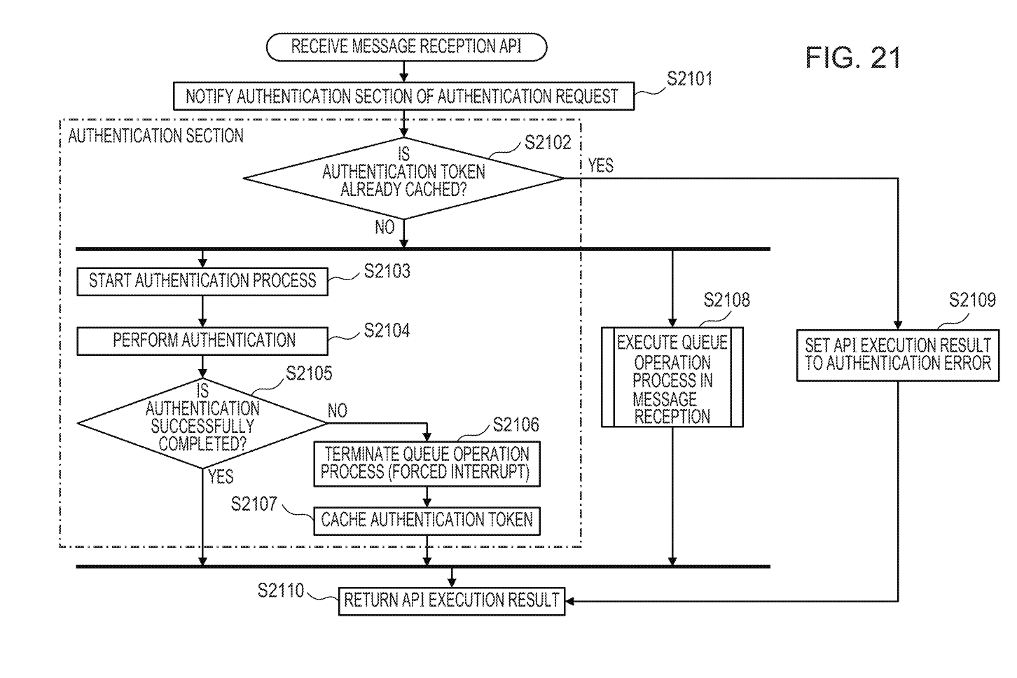

Next, an operational flow of the message reception process is described. FIG. 21 is a diagram illustrating the operational flow of the message reception process according to the second embodiment. The operational flow of the message reception process illustrated in FIG. 21 may be started when the controller 1801 of the message processing device 101 receives a message reception API.

In S2101, the controller 1801 of the message processing device 101 acquires an authentication token included in the received message reception API and identification information identifying a queue in which a message is stored, and the controller 1801 notifies the authentication section 1813 of an authentication request. In S2102, the authentication section 1813 determines whether or not an authentication token identical to the authentication token included in the authentication request is already stored in the cache 1200.

When an authentication token identical to the authentication token is already stored in the cache 1200 (YES in S2102), the flow proceeds to S2109. In S2109, the controller 1801 sets information indicating an authentication error to an API execution result. Then, the flow proceeds to S2110. In S2110, the controller 1801 returns the API execution result, to which information indicating an authentication error is set, to the information processing device 102 that calls the message reception API.

When no authentication token identical to the authentication token is stored in the cache 1200 (NO in S2102), the controller 1801 and the authentication section 1813 start processes in parallel. The authentication section 1813 starts an authentication process in S2103 and performs authentication in S2104. In S2105, the authentication section 1813 determines, based on the result of the authentication, whether or not the authentication was successfully completed. When the authentication is successfully completed (YES in S2105), the authentication section 1813 terminates the authentication process and stands by until the completion of the process executed by the controller 1801.

When the authentication fails (NO in S2105), the flow proceeds to S2106. In S2106, the authentication section 1813 outputs a notification indicating a forced interrupt to the controller 1801 and terminates the queue operation process. In S2107, the authentication section 1813 causes the authentication token for which the authentication fails to be stored as an invalid authentication token in the cache 1200. Then, the authentication section 1813 terminates the authentication process and stands by until the completion of the process executed by the controller 1801.

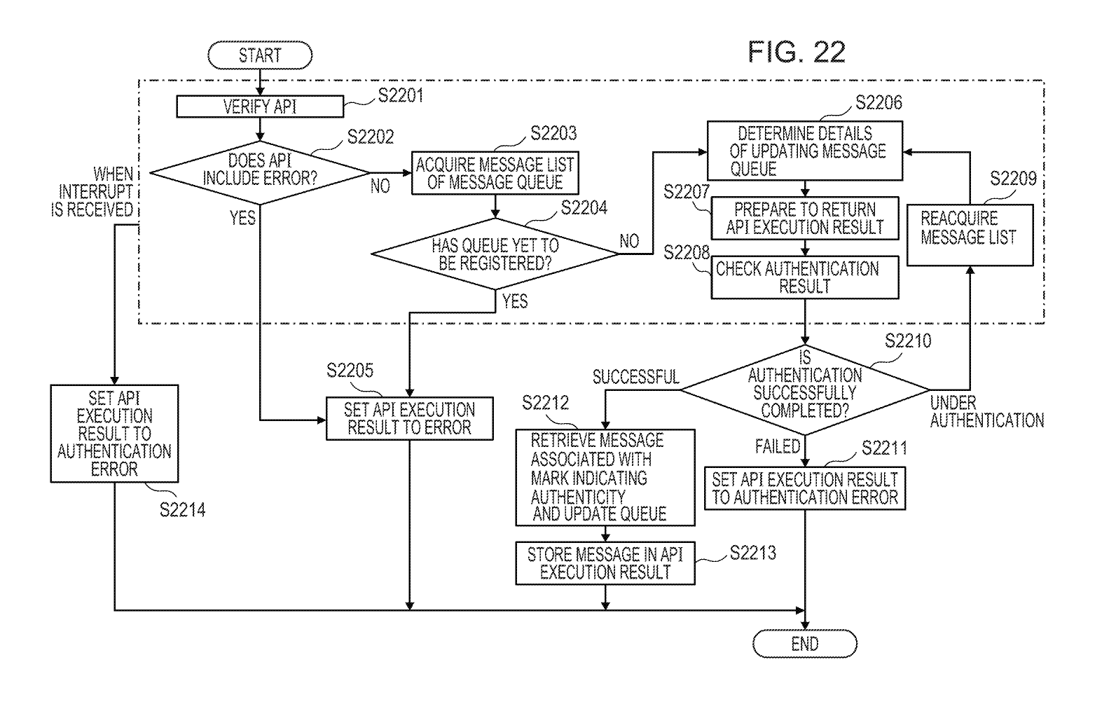

The controller 1801 executes a queue operation process in the message reception in S2108 in parallel with the authentication process executed by the authentication section 1813. The queue operation process executed in the message reception is described later in detail with reference to FIG. 22. When the queue operation process of S2108 is completed, the controller 1801 stands by until the completion of the authentication process executed by the authentication section 1813.

When the process executed by the controller 1801 and the authentication process executed by the authentication section 1813 are completed, the controller 1801 returns the API execution result to the information processing device 102 that calls the message reception API. In this case, the API execution result may include the message retrieved from the message queue, for example.

FIG. 22 is a diagram illustrating a queue operation process in the message reception according to the second embodiment. For example, when the flow proceeds to S2108 in FIG. 21, the controller 1801 may start executing the queue operation process illustrated in FIG. 22.

In S2201, the controller 1801 verifies the validity of the message reception API. For example, the controller 1801 verifies whether or not a parameter set in the message reception API is valid and whether or not the format of the data transmitted by the message reception API is valid. In S2202, the controller 1801 determines whether or not the message reception API includes an error. When the message reception API includes an error as a result of the API verification (YES in S2202), the flow proceeds to S2205. In S2205, the controller 1801 sets the API execution result to an error. Then, this operational flow is terminated and the flow of the message reception process proceeds to S2110 in FIG. 21.

When the message reception API includes no error as a result of the API verification (NO in S2202), the flow proceeds to S2203. In S2203, the controller 1801 tries to acquire a message list registered in the message queue specified as a queue to be operated in the message reception API. For example, the controller 1801 references the storage area information 2300 to identify a storage area corresponding to identification information identifying the message queue in which the message is to be stored. Then, the controller 1801 acquires information from the message queue stored in the storage area to generate the message list. The message list may include a unique ID of the message and information of the mark indicating authenticity, which is associated with the message. In S2204, the controller 1801 determines whether or not the message queue 1100, which is specified in the message reception API as the queue to be operated, is yet to be registered. When the message queue 1100, which is specified in the message reception API as the queue to be operated, is yet to be registered (YES in S2204), the flow proceeds to S2205.

When the message queue 1100, which is specified in the message reception API as the queue to be operated, is already registered in the storage section 1802 (NO in S2204), the flow proceeds to S2206. In S2206, the controller 1801 determines details of updating the message queue 1100. In the determination of the details of updating, the controller 1801 may determine which message registered in the message queue 1100 is to be received from the storage section 1802 and which message registered in the message queue 1100 is to be changed to which value, based on the information of the mark indicating authenticity, which is associated with messages in the message list.

In S2207, the controller 1801 sets already fixed information in an API execution result to prepare to return the API execution result. For example, the controller 1801 may set, in the API execution result, a unique ID of the received message reception API and information such as the reception time of the received message reception API. In S2208, the controller 1801 notifies the authentication section 1813 of a confirmation request for confirming authenticity to check the result of the authentication. In S2210, the controller 1801 determines whether or not the authentication is successfully completed.

When the authentication is being performed in S2210 (“under authentication” in S2210), the controller 1801 reacquires the message list of the message queue 1100 to identify a message with which the mark indicating authenticity is associated in S2209. Then, the flow returns to S2206 and the controller 1801 re-determines details of updating the message queue.

When the authentication fails (“failed” in S2210), the flow proceeds to S2211, and the controller 1801 sets information indicating an authentication error to the API execution result in S2211. When the authentication is successfully completed (“successful” in S2210), the flow proceeds to S2212.

In S2212, the controller 1801 retrieves, from the message queue 1100, the message with which the mark indicating authenticity is associated, and the controller 1801 deletes an entry including the retrieved message to update the message queue 1100. In S2213, the controller 1801 causes the message retrieved from the message queue 1100 to be stored in the API execution result. Then, this operational flow is terminated.

When the controller 1801 receives an interrupt from the authentication section 1813 during the processes of S2201 to S2209, the flow proceeds to S1614. In S1614, the controller 1801 sets information indicating an authentication error to the API execution result, and this operational flow is terminated.

As described above, the message processing device 101 may have the functions of the authentication server 103 and data server 104 to execute the processes thereof.

In the second embodiment, upon receiving, from the information processing device 102, a message transmission API including a message and identification information identifying a message queue in which the message is to be stored, the controller 1801 references the storage area information 2300 of the storage section 1802. Then, the controller 1801 identifies a storage area corresponding to the identification information. The controller 1801 causes the received message to be stored in the message queue stored in the identified storage area. In addition, the controller 1801 performs authentication to determine whether or not the information processing device 102 has the right to cause the message to be stored in the identified message queue. When the information processing device 102 has the right, the controller 1801 stores the mark indicating authenticity in association with the message stored in the identified message queue. Thus, in the second embodiment, a time elapsed for transmission to a message queue may be reduced. In S1906, the controller 1801 operates as the storage controller 1811, for example.

In the second embodiment, upon receiving, from the information processing device 102, a message reception API including identification information identifying a message queue in which a message is stored, the controller 1801 references the storage area information 2300 stored in the storage section 1802. Then, the controller 1801 identifies the message queue stored in a storage area corresponding to the identification information. In addition, the controller 1801 performs authentication to determine whether or not the information processing device 102 has the right to acquire the message stored in the identified message queue. When the information processing device 102 has the right, the controller 1801 retrieves the message stored in the identified message queue. Thus, in the second embodiment, a time elapsed for receiving a message from a message queue may be reduced. In S2212 in FIG. 22, the controller 1801 operates as the acquisition section 1812.

Thus, according to the second embodiment, the processing performance of the message queue system 1700 may be improved.

Although some embodiments are disclosed, embodiments are not limited to the disclosed embodiments. For example, operational flows are not limited to the aforementioned operational flows. In the operational flows, the processes may be executed in a different order, or a different process may be included, or a part of the processes may be omitted. For example, the order of S1307 and S1308 in FIG. 13 may be reversed, and the order of S1506 and S1507 may be reversed.

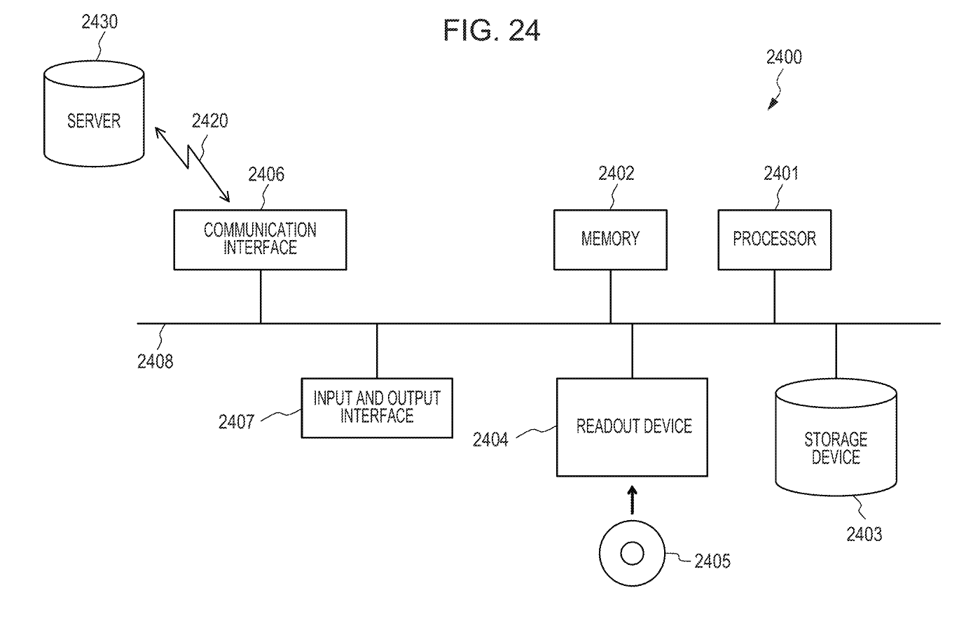

FIG. 24 is a diagram illustrating a hardware configuration of a computer 2400 that achieves the message processing device 101 according to the embodiments. For example, the information processing device 102, the authentication server 103, and the data server 104 may have the hardware configuration illustrated in FIG. 24. The computer 2400 illustrated in FIG. 24 includes a processor 2401, a memory 2402, a storage device 2403, a readout device 2404, a communication interface 2406, and an input and output interface 2407. The processor 2401, the memory 2402, the storage device 2403, the readout device 2404, the communication interface 2406, and the input and output interface 2407 are coupled to each other via a bus 2408.

The processor 2401 provides a part or all of the functions of the controller 301 or 1801 by using the memory 2402 to execute a program in which procedures for the operational flows described in the first or second embodiment are described. The storage section 302 or 1802 includes the memory 2402, the storage device 2403, and a removable storage medium 2405. The processor 2401 of the message processing device 101 may read and execute a program stored in the storage device 2403 to operate as the operation section 311, the authentication section 312, the request section 321, the output section 322, the determination section 323, and the acquisition section 324. The processor 2401 of the message processing device 101 may read and execute a program stored in the storage device 2403 to operate as the storage controller 1811, the acquisition section 1812, and the authentication section 1813. In the storage device 2403 of the message processing device 101, the cache 1200 may be stored. In the storage device 2403 of the data server 104, the message queue 1100 may be stored. In the storage device 2403 of the message processing device 101, the message queue 1100, the cache 1200, and the storage area information 2300 may be stored.

The memory 2402 is, for example, a semiconductor memory and may include a random access memory (RAM) region and a read-only memory (ROM) region. The storage device 2403 is, for example, a hard disk, a semiconductor memory such as a flash memory, or an external storage device.

The readout device 2404 accesses the removable storage medium 2405 in accordance with an instruction from the processor 2401. The removable storage medium 2405 is achieved by a semiconductor device (universal serial bus (USB) memory or the like), a medium (magnetic disk or the like) in and from which information is input and output by a magnetic effect, a medium (compact disc ROM (CD-ROM), digital versatile disc (DVD), or the like) in and from which information is input and output by an optical effect, or the like, for example.

The communication interface 2406 transmits and receives data via a network 2420 in accordance with instructions from the processor 2401. The communication section 303 may be the communication interface 2406, for example. The input and output interface 2407 may be an interface with an input device and with an output device, for example. The input device receives an instruction from a user and is a keyboard, a mouse, or the like, for example. Examples of the output device are a display device such as a display and an audio device such as a speaker.

The programs according to the embodiments are provided to the message processing devices 101 in the following manners.

(1) The programs are installed in the storage device 2403 in advance.

(2) The programs are provided from the removable storage medium 2405.

(3) The programs are provided from a server 2430 such as a program server.

The hardware configuration, described with reference to FIG. 24, of the computer 2400 that achieves the message processing devices 101 is an example, and the hardware configuration is not limited to this. For example, a part or all of the aforementioned functional sections may be implemented as hardware such as a field programmable gate array (FPGA) and a System-on-a-Chip (SoC).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A message processing method, comprising:
receiving, by a computer, a transmission instruction from a first information processing device, the transmission instruction including a first message, first authentication information to be used for first authentication of authenticating a first user, and first identification information for identifying a first storage area;
identifying the first storage area by using the first identification information;
storing the first message in the identified first storage area;
performing the first authentication by using the first authentication information; and
storing, when the first authentication is successfully completed, information indicating authenticity in the first storage area in association with the first message.

2. The message processing method according to claim 1, further comprising:
notifying the first information processing device of a response to the transmission instruction before a result of the first authentication is obtained.

3. The message processing method according to claim 1, further comprising:
determining, upon receiving the transmission instruction, whether information identical to the first authentication information is already stored in a storage device;
notifying, when information identical to the first authentication information is already stored in the storage device, the first information processing device of first error information without storing the first message in the first storage area and without performing the first authentication, the first error information indicating that the first authentication fails, the first error information being included in a response to the transmission instruction; and
storing the first authentication information in the storage device when the first authentication fails.

4. The message processing method according to claim 1, further comprising:
receiving a reception instruction from a second information processing device, the reception instruction including second authentication information to be used for second authentication of authenticating a second user and second identification information for identifying a second storage area;
performing the second authentication by using the second authentication information;
acquiring, when the second authentication is successfully completed, a second message stored in the second storage area identified by the second identification information, the second message being associated with the information indicating authenticity; and
transmitting the second message to the second information processing device.

5. The message processing method according to claim 4, further comprising:
identifying, before a result of the second authentication is obtained, the second message from among messages stored in the second storage area.

6. The message processing method according to claim 4, further comprising:
determining, upon receiving the reception instruction, whether information identical to the second authentication information is already stored in a storage device;
notifying, when information identical to the second authentication information is already stored in the storage device, the second information processing device of second error information without performing the second authentication, the second error information indicating that the second authentication fails, the second error information being included in a response to the reception instruction; and
storing the second authentication information in the storage device when the second authentication fails.

7. A non-transitory computer-readable recording medium having stored therein a program that causes a computer to execute a process, the process comprising:
receiving a transmission instruction from a first information processing device, the transmission instruction including a first message, first authentication information to be used for first authentication of authenticating a first user, and first identification information for identifying a first storage area;
identifying the first storage area by using the first identification information;
storing the first message in the identified first storage area;
performing the first authentication by using the first authentication information; and
storing, when the first authentication is successfully completed, information indicating authenticity in the first storage area in association with the first message.

8. The non-transitory computer-readable recording medium according to claim 7, the process further comprising:
receiving a reception instruction from a second information processing device, the reception instruction including second authentication information to be used for second authentication of authenticating a second user and second identification information for identifying a second storage area;
performing the second authentication by using the second authentication information;
acquiring, when the second authentication is successfully completed, a second message stored in the second storage area identified by the second identification information, the second message being associated with the information indicating authenticity; and
transmitting the second message to the second information processing device.

9. A message processing device, comprising:
a memory; and
a processor coupled to the memory and the processor configured to:
receive a transmission instruction from a first information processing device, the transmission instruction including a first message, first authentication information to be used for first authentication of authenticating a first user, and first identification information for identifying a first storage area;
identify the first storage area by using the first identification information;
store the first message in the identified first storage area;
perform the first authentication by using the first authentication information; and
store, when the first authentication is successfully completed, information indicating authenticity in the first storage area in association with the first message.

10. The message processing device according to claim 9, wherein
the processor is configured to:
receive a reception instruction from a second information processing device, the reception instruction including second authentication information to be used for second authentication of authenticating a second user and second identification information for identifying a second storage area;
perform the second authentication by using the second authentication information;
acquire, when the second authentication is successfully completed, a second message stored in the second storage area identified by the second identification information, the second message being associated with the information indicating authenticity; and
transmit the second message to the second information processing device.
